(19) United States
(12) Patent Application Publication
(10) Pub. No.: US 2012/0050304 A1
(43) Pub. Date: Mar. 1, 2012

(54) IMAGE PROCESSING APPARATUS, METHOD, AND PROGRAM

(75) Inventors: Norihiro NAKAMURA, Kanagawa-ken (JP); Toshiaki Nakasu, Kanagawa-ken (JP); Yasunobu Yamauchi, Kanagawa-ken (JP)

(73) Assignee: KABUSHIKI KAISHA TOSHIBA, Tokyo (JP)

(21) Appl. No.: 13/050,571

(22) Filed: Mar. 17, 2011

(30) Foreign Application Priority Data
Aug. 30, 2010 (JP) P2010-192736

(51) Int. Cl. G09G 5/02

(52) U.S. Cl. 345/589

(57) ABSTRACT

When the smallest transformation cost among transformation costs calculated for respective coordinates of integration points is determined to be equal to or more than a predetermined threshold value, a dividing unit inserts a virtual point to the a mesh to divide a triangular patch including the virtual point. When the smallest transformation cost among the transformation costs calculated for the respective coordinates of the integration points is determined to be less than the predetermined threshold value, a transformation unit moves a vertex, which is opposite to the virtual point, of an edge having the integration point to a position of the coordinate of the integration point having the transformation cost, thereby transforming the triangular patch.

### CROSS-REFERENCE TO RELATED APPLICATION

This application is based upon and claims the benefit of priority from Japanese Patent Application No. P2010-192736, filed on Aug. 30, 2010; the entire contents of which are incorporated herein by reference.

### FIELD

Embodiments described herein generally relate to an image processing apparatus, a method, and a program.

### BACKGROUND

There is an image processing method for easily performing image processing such as resolution conversion by generating an approximate image obtained by approximating a pixel image such as a picture using a mesh which is a set of patches, i.e., geometric shapes such as a triangular surface.

In the image processing method, the mesh approximating the pixel image is generated and drawn using the plurality of patches having luminance information based on luminance of pixels in the pixel image.

In this image processing method, it is desired to reduce the amount of data representing the mesh to be drawn.

### BRIEF DESCRIPTION OF THE DRAWINGS

FIG. 1 is a block diagram illustrating a configuration of an image processing apparatus 1 according to a first embodiment;

FIG. 2 is a flowchart illustrating processing of the image processing apparatus 1;

FIGS. 3A and 3B are figures illustrating virtual space according to the first embodiment;

FIGS. 4A and 4B are conceptual diagrams illustrating how a second calculation unit 105 divides triangular patches;

FIGS. 5A and 5B are figures illustrating an example of an integration point Pn; and

FIGS. 6A and 6B are figures illustrating an example of triangular patches transformed by a transformation unit 108.

FIG. 7 is a figure illustrating the expression 1 to calculate the degree of approximation.

### DETAILED DESCRIPTION

An object of the present embodiment is to provide an image processing apparatus, a method, and a program capable of reducing the amount of data representing a mesh to be drawn.

In order to solve the above problem, an image processing apparatus according to an embodiment of the present invention includes a generation unit, a first calculation unit, a first determination unit, a second calculation unit, a second determination unit, a dividing unit, and a transformation unit. The generation unit generates a mesh including a plurality of triangular patches in a virtual space defined by a position and a luminance, wherein the mesh has vertices at points corresponding to pixels at corners of an input pixel image. The first calculation unit calculates a degree of approximation of an image quality of each of the triangular patches with respect to the input image, on the basis of a difference between a luminance of each pixel of the pixel image and a luminance of each of the triangular patches corresponding to each pixel, and further calculates a maximum pixel at which the difference is the largest. The first determination unit determines whether the degree of approximation is less than a predetermined threshold value.

When the degree of approximation is determined to be less than the predetermined threshold value, the second calculation unit inserts a virtual point at a coordinate of the maximum pixel, generates an edge connecting between the virtual point and each vertex of the triangular patch including the virtual point, calculates, for each edge, a coordinate of an integration point obtained by uniting the virtual point and the vertex, and calculates, for each of the coordinates of the integration points, a transformation cost based on distances from the plurality of triangular patches. The second determination unit determines whether the smallest transformation cost among the transformation costs calculated for the respective coordinates of the integration points is less than a predetermined threshold value. When the smallest transformation cost among the transformation costs calculated for the respective coordinates of the integration points is determined to be equal to or more than the predetermined threshold value, the dividing unit inserts the virtual point to the mesh to divide the triangular patch including the virtual point.

When the smallest transformation cost among the transformation costs calculated for the respective coordinates of the integration points is determined to be less than the predetermined threshold value, the transformation unit moves the vertex, which is opposite to the virtual point, of the edge having the integration point to a position of the coordinate of the integration point having the transformation cost, thereby transforming the triangular patch.

Embodiments of the present invention will be hereinafter explained in detail with reference to drawings.

In the specification and drawings of the present application, the same elements as those in the already shown drawings are denoted with the same reference numerals, and detailed description thereabout is not repeated here.

### First Embodiment

An image processing apparatus 1 according to the first embodiment converts a pixel image represented by a pixel coordinate (x, y) and a luminance Ic into a mesh in a virtual space defined by a coordinate system (x, y, I) of a pixel coordinate (x, y) and a luminance I, and draws the mesh.

The image processing apparatus 1 generates an initial mesh including a plurality of patches (for example, two patches) based on the pixel image. The image processing apparatus 1 compares the mesh with the pixel image, and determines whether to increase the number of patches included in the mesh by inserting a new vertex, or whether to transform the mesh by moving an existing vertex.

Thereby, it can be provided that the image processing apparatus 1 generates the mesh which is not deteriorated in the quality of the image as compared with the pixel image, while the number of patches is prevented from increasing.

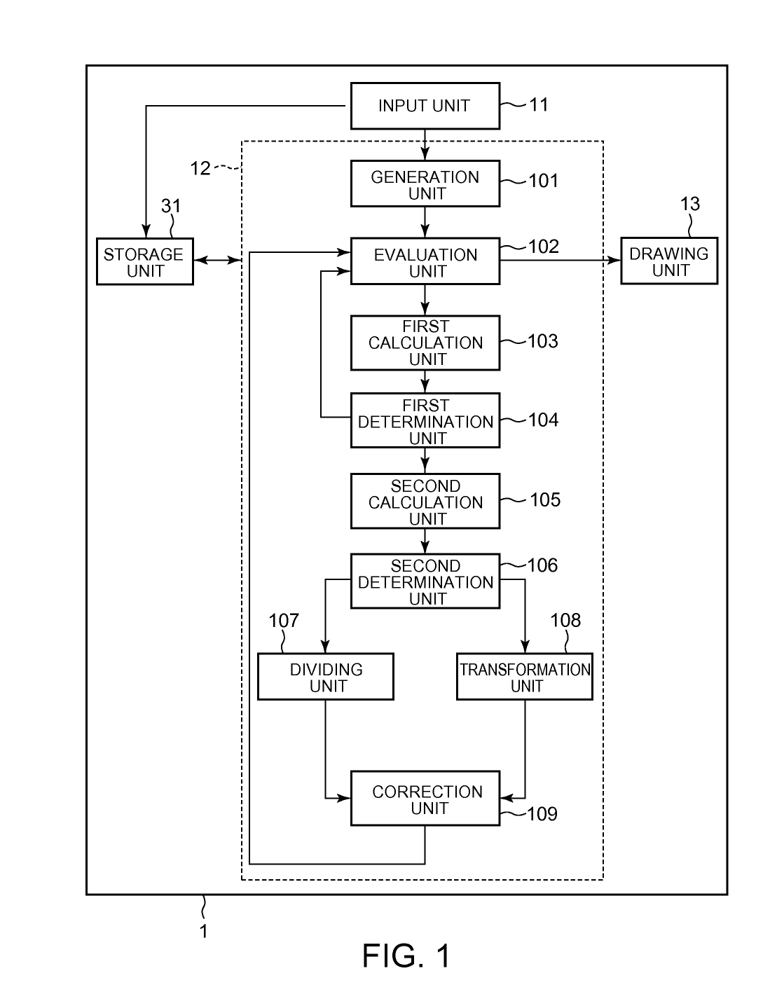

FIG. 1 is a block diagram illustrating a configuration of the image processing apparatus 1. The image processing apparatus 1 includes an input unit 11, a processing unit 12, drawing unit 13, and a storage unit 31. The processing unit 12 includes a generation unit 101, an evaluation unit 102, a first calculation unit 103, a first determination unit 104, a second calculation unit 105, a second determination unit 106, a dividing unit 107, a transformation unit 108, and a correction unit 109. The processing unit 12 may be achieved with a CPU and a memory used by the CPU. The storage unit 31 may be achieved with the memory used by the CPU. The drawing unit 13 may be achieved with a GPU and a memory used by the GPU.

The input unit 11 is used to input a pixel image (input image). The input image includes pixel data (x, y, Ic) including a luminance Ic of each color component c (for example, c=(R, G, B)) of each pixel (x, y). The storage unit 31 stores the input image obtained from the input unit 11, and stores the generated mesh. In the present embodiment, the center of a pixel is assumed to be an xy coordinate of the pixel. The input image may be an image obtained by converting an image of a still picture or one frame of a motion picture into pixel data.

The generation unit 101 reads pixel data of pixels at corners of the entire input image from the storage unit 31. When the input image is a rectangle, the generation unit 101 reads, from the storage unit 31, pixel data P1 (x1, y1, Ic1), P2 (x2, y2, Ic2), P3 (x3, y3, Ic3), P4 (x4, y4, Ic4) of a color component c of pixels at four corners of the entire input image. In the present embodiment, the input image is assumed to be a rectangle.

In the virtual space, the generation unit 101 adopts, as vertices, the pixel data P1 (x1, y1, Ic1), P2 (x2, y2, Ic2), P3 (x3, y3, Ic3), P4 (x4, y4, Ic4) of the pixels at the corners of the entire input image.

From among the vertices P1 to P4, the generation unit 101 selects one of two pairs of diagonally located vertices (for example, either P1 and P3 or P2 and P4) having a smaller difference of luminance Ic, and generates an edge connecting the thus selected pair of diagonally located vertices.

The generation unit 101 generates edges connecting between the two vertices at both ends of the edge and the remaining two vertices, thus generating an initial mesh including two triangular patches. The mesh can be represented as data including information about the coordinates of the vertices and information representing connection relationship of the edges among the vertices (for example, a vertex P1 is connected with vertices P2, P3, P4 via edges).

In addition, the generation unit 101 may attach a “vertex ID”, i.e., an identification number of a vertex, to each vertex. A “edge ID”, i.e., an identification number of an edge, may be attached to each edge. A “patch ID”, i.e., an identification number of a triangular patch, may be attached to each triangular patch. The generation unit 101 writes the initial mesh to the storage unit 31. The generation unit 101 may represent any given triangular patch with an expression of surface represented by a luminance I(x, y) at a position (x, y).

The evaluation unit 102 evaluates whether the degrees of approximations S (later explained) of all the triangular patches included in the mesh have already been calculated.

The first calculation unit 103 selects and reads a triangular patch whose degree of approximation S has not yet been calculated (for example, patch ID=1) from the storage unit 31.

The first calculation unit 103 reads pixel data (x, y, Ic) of the input image from the storage unit 31. At this occasion, the first calculation unit 103 reads, from the storage unit 31, pixel data (x, y, Ic) of a portion where the triangular patch includes the xy coordinate.

For each piece of the pixel data, the first calculation unit 103 obtains a difference between a luminance Ic of the pixel data (x, y, Ic) in the input image and a luminance I (x, y) corresponding to a point having the xy coordinate in the triangular patch. The first calculation unit 103 calculates, on the basis of the thus obtained difference, the degree of approximation S representing the degree of approximation of the image quality of the triangular patch with respect to the portion of the input image approximated by the triangular patch.

When the first calculation unit 103 calculates the degree of approximation S, the first calculation unit 103 obtains pixel data Ps (xₛ, yₛ, Icₛ) of the input image where the difference of luminance from the triangular patch is the largest (which is referred to as maximum pixel data). The first calculation unit 103 provides the degree of approximation S and the maximum pixel data Ps to the first determination unit 104.

The first determination unit 104 determines whether the degree of approximation S is less than a predetermined threshold value or not. When the degree of approximation S is determined to be less than the predetermined threshold value, the first determination unit 104 notifies the coordinate Ps (xₛ, yₛ, Icₛ) to the second calculation unit 105. When the degree of approximation S is determined to be less than the predetermined threshold value, the first determination unit 104 requests the evaluation unit 102 to perform the evaluation as described above.

The second calculation unit 105 reads the mesh from the storage unit 31. The second calculation unit 105 inserts a virtual point at the coordinate Ps of the mesh (hereinafter referred to as virtual point Ps).

The second calculation unit 105 generates three edges connecting between the virtual point Ps and the vertices of the triangular patch including the virtual point Ps, thus dividing the triangular patch. At the same time, the second calculation unit 105 removes the undivided triangular patch from the mesh.

For each edge, the second calculation unit 105 obtains a coordinate of an integration point Pn (n=1, 2, 3), i.e., a point obtained by uniting the points at both ends of each edge (the virtual point Ps and one vertex). This will be explained in detail later. For each edge, the second calculation unit 105 calculates a “transformation cost” representing a summation of distances between the integration point Pn and other triangular patches. This will be explained in detail later. The second calculation unit 105 provides the transformation cost of each edge to the second determination unit 106.

The second determination unit 106 determines whether the smallest transformation cost among the transformation costs calculated for the respective edges is less than a predetermined threshold value defined in advance. When the smallest transformation cost is equal to or more than the predetermined threshold value, the second determination unit 106 notifies the coordinate (xₛ, yₛ, ICₛ) of the virtual point Ps to the dividing unit 107.

The dividing unit 107 reads the mesh from the storage unit 31. The dividing unit 107 inserts the notified virtual point Ps into the mesh, draws an edge between the virtual point Ps and each vertex of the triangular patch including the virtual point Ps, and divides the triangular patch. At the same time, the dividing unit 107 removes the undivided triangular patch from the mesh.

When the transformation cost is determined to be less than the predetermined threshold value, the second determination unit 106 determines an edge having the smallest transformation cost from among the three edges, and the second determination unit 106 notifies, to the transformation unit 108, the vertex ID of the vertex, which is opposite to the virtual point Ps, of the determined edge and the coordinate of the integration point Pn corresponding to the determined edge.

The transformation unit 108 reads the mesh from the storage unit 31. The transformation unit 108 moves the vertex having the vertex ID thus notified to the coordinate of the notified integration point, thereby transforming the triangular patch.

The correction unit 109 corrects the mesh by swapping the edges of the mesh so that the plurality of triangular patches included in the mesh divided by the dividing unit 107 or the mesh changed by the transformation unit 108 are in accordance with the rule of Delaunay triangulation. At this occasion, edges corresponding to the borders of the mesh may not be subjected to swapping. It should be noted that the Delaunay triangulation means dividing a triangle in such a manner that no other point is inside the circumcircle of each triangle.

The correction unit 109 updates the mesh by writing the corrected mesh to the storage unit 31.

The drawing unit 13 draws the mesh.

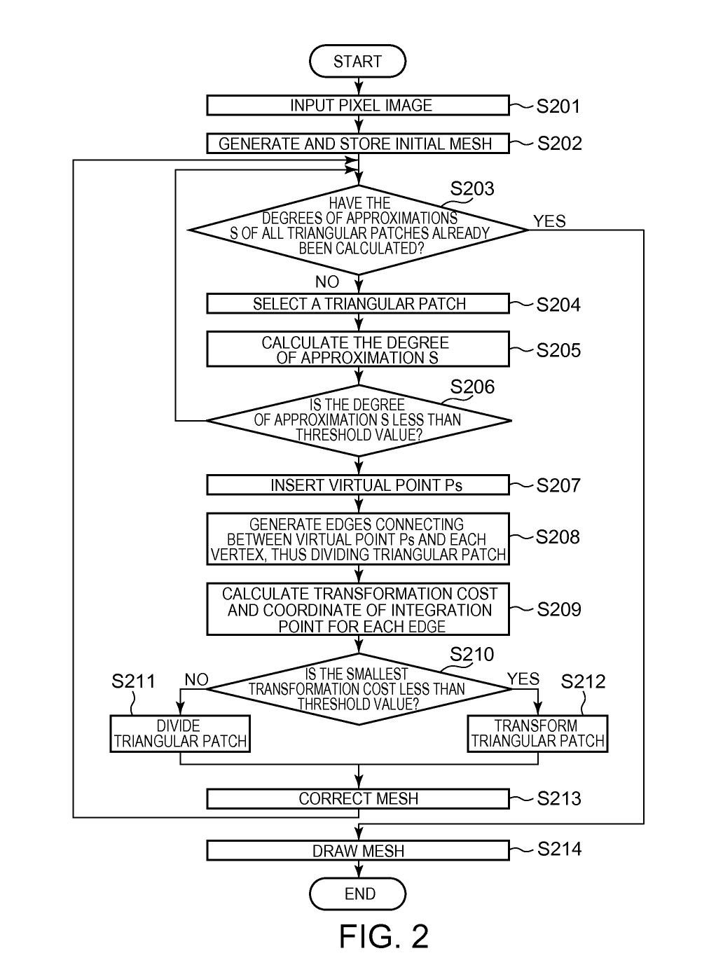

FIG. 2 is a flowchart illustrating processing of the image processing apparatus 1.

The input unit 11 inputs a pixel image (input image) (S201). The input unit 11 writes the input image to the storage unit 31.

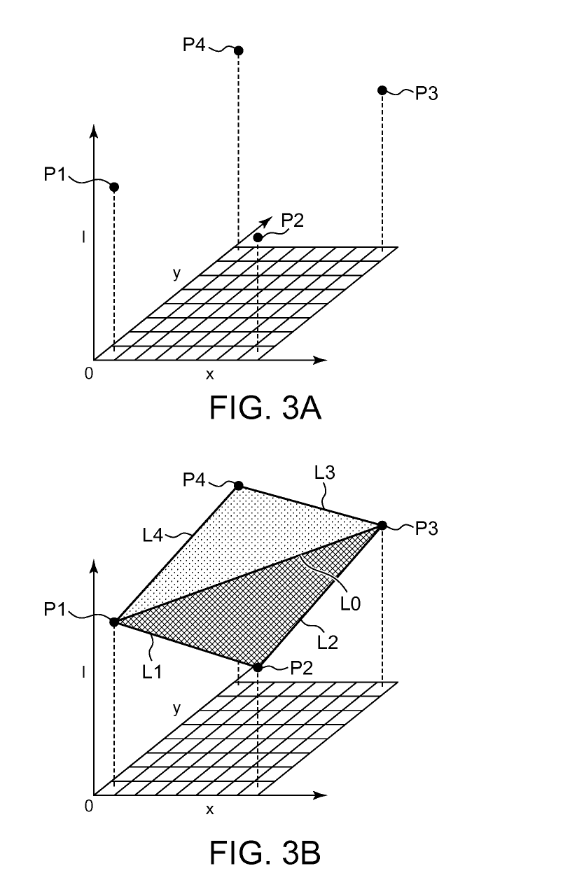

The generation unit 101 generates an initial mesh (S202) FIGS. 3A and 3B are figures illustrating virtual space according to the present embodiment. In the present embodiment, as shown in FIG. 3A, the generation unit 101 reads, from the storage unit 31, pixel data P1 (x1, y1, Ic1), P2 (x2, y2, Ic2), P3 (x3, y3, Ic3), 94 (x4, y4, Ic4) of a color component c of pixels at four corners of the entire input image, and adopts pixel data P1 (x1, y1, Ic1), P2 (x2, y2, Ic2), P3 (x3, y3, Ic3), P4 (x4, y4, Ic4) as the vertices in the virtual space.

The generation unit 101 calculates a difference (absolute value) of the luminance Ic of each of two pairs of diagonally located vertices of the vertices P1 to P4 (S203). For example, regarding the vertex P1 and the vertex P3, the generation unit 101 calculates a difference between the luminance of the vertex P1 and the luminance of the vertex P3, i.e., the generation unit 101 calculates α= [symbol] lc1−lc3 [symbol] . Further, regarding the vertex P2 and the vertex P4, the generation unit 101 calculates a difference between the luminance of the vertex P2 and the luminance of the vertex P4, i.e., the generation unit 101 calculates β= [symbol] lc2−lc4 [symbol] .

The generation unit 101 compares α and β, and generates an edge L0 connecting the vertices having a smaller difference of luminance. The generation unit 101 generates edges connecting between the vertices at both ends of the edge and the remaining vertices, thus generating an initial mesh including two triangular patches.

For example, when α<β holds, the generation unit 101 generates the edge L0 connecting between the vertex P1 and the vertex P3 as shown in FIG. 3B. The generation unit 101 generates edges (edges L1, L2, L3, L4) connecting between the vertices at both ends of the edge L0 (the vertex P1 and the vertex P3) and the other vertices (the vertex P2 and the vertex P4), thus generating an initial mesh including two triangular patches. The generation unit 101 writes the initial mesh to the storage unit 31.

The evaluation unit 102 evaluates whether the degrees of approximations S of all the triangular patches included in the mesh have already been calculated (S203). For example, a flag indicating whether the degree of approximation S has been calculated or not is attached to each patch ID, and the flag and the patch ID are stored in the storage unit 31. The evaluation unit 102 may perform the evaluation of step S203 using the flags.

When the determination made in step S203 is NO, the first calculation unit 103 selects and reads a triangular patch whose degree of approximation S has not been calculated (for example, patch ID=1) from the storage unit 31 (S204). The first calculation unit 103 reads, from the storage unit 31, pixel data (x, y, Ic) of a portion of the input image where the pixel coordinate (x, y) corresponds to the xy coordinate of the triangular patch.

For each piece of the pixel data, the first calculation unit 103 obtains a difference between a luminance Ic of the pixel data (x, y, Ic) in the input image and a luminance I (x, y) corresponding to a point having the xy coordinate in the triangular patch. The first calculation unit 103 calculates, based on the thus obtained difference, the degree of approximation S of the triangular patch with respect to the portion of the input image approximated by the triangular patch (S205).

When the first calculation unit 103 calculates the degree of approximation S, the first calculation unit 103 obtains pixel data Ps (xₛ, yₛ, Icₛ) of the input image where the difference of luminance from the triangular patch is the largest (which is referred to as maximum pixel data).

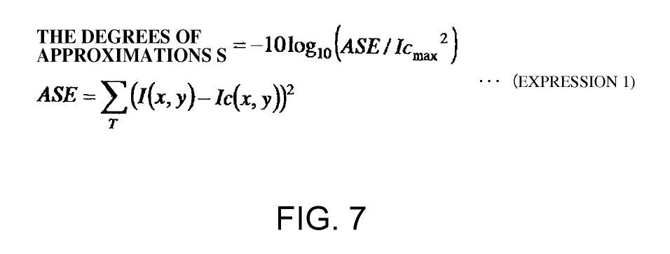

For example, for each pixel, the first calculation unit 103 may calculate a difference between the luminance Ic (x, y) of the pixel and the luminance I (x, y) of the triangular patch, i.e., “I(x, y)−Ic(x, y)”. At this occasion, the first calculation unit 103 obtains the maximum pixel data Ps (xₛ, yₛ, Inₛ). The first calculation unit 103 may calculate the degree of approximation S using the difference of luminance, “I(x, y)−Ic(x, y)”. For example, the first calculation unit 103 may use the expression 1 as shown in FIG. 7 to calculate the degree of approximation S.

In the expression 1, T indicates that a sum of squares of “I(x, y)−Ic(x, y)” is calculated for a pixel included in an xy coordinate of a triangular patch.

In the present embodiment, the first calculation unit 103 calculates the degree of approximation S as described above. However, the calculation method is not limited thereto. The first calculation unit 103 may calculate the degree of approximation S using any method as long as the image quality of the triangular patch with respect to the input image can be evaluated.

The first calculation unit 103 provides the degree of approximation S and the maximum pixel data Ps to the first determination unit 104. The first determination unit 104 determines whether the degree of approximation S is less than a predetermined threshold value or not (S206). When the degree of approximation S is determined to be less than the predetermined threshold value, the first determination unit 104 notifies the coordinate Ps (xₛ, yₛ, Icₛ) to the second calculation unit 105.

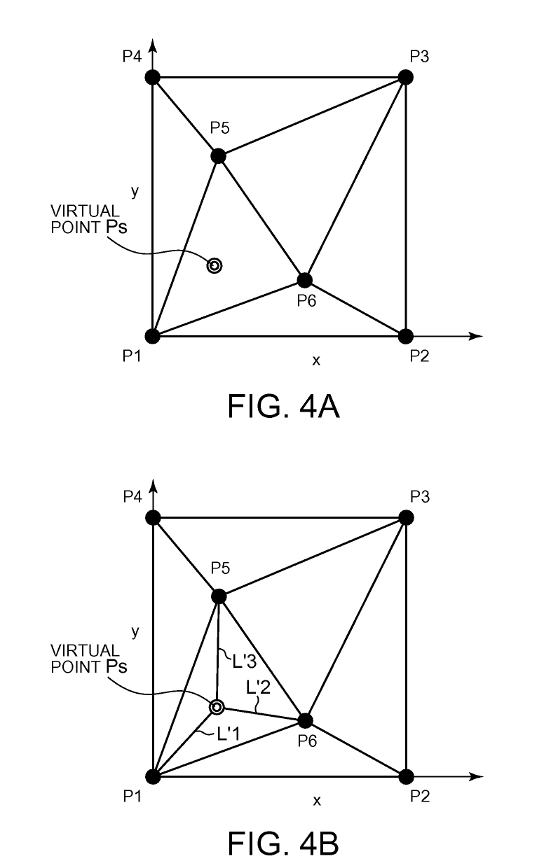

FIGS. 4A and 4B are conceptual diagrams illustrating how the second calculation unit 105 divides triangular patches. For the sake of explanation, processing performed with a mesh having six triangular patches will be explained.

The second calculation unit 105 reads the mesh from the storage unit 31. The second calculation unit 105 inserts a virtual point Ps at a coordinate Ps of the mesh (S207) (FIG. 4A).

The second calculation unit 105 generates three edges (edges L′1, L′2, L′3) connecting between the virtual point Ps and each vertex of the triangular patch including the virtual point Ps, thus dividing the triangular patch (S208) (FIG. 4B). At the same time, the second calculation unit 105 removes the undivided triangular patch from the mesh.

For each edge, the second calculation unit 105 calculates a coordinate of an integration point Pn (n=1, 2, 3), i.e., a point obtained by uniting the points at both ends of each edge (the virtual point Ps and one vertex) (S209).

The second calculation unit 105 may read, from the storage unit 31, only the triangular patch including the virtual point Ps and a plurality of triangular patches sharing at least one vertex.

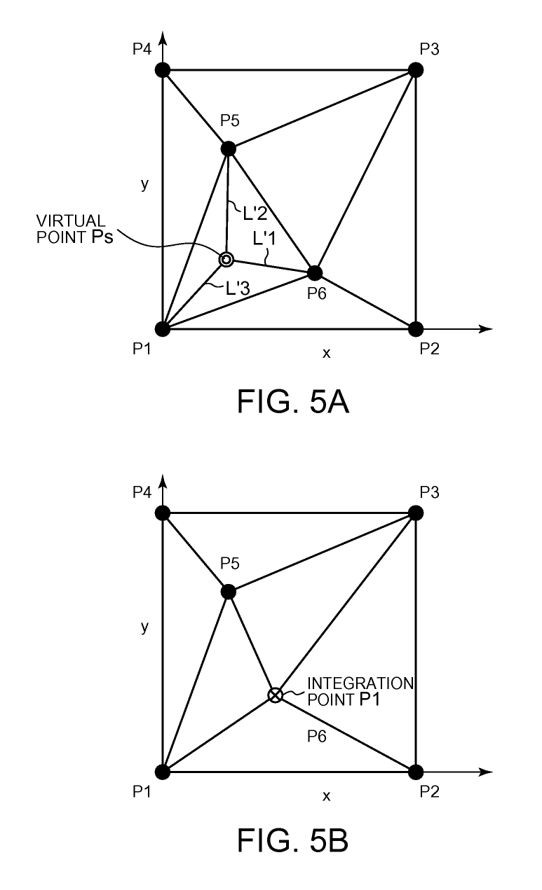

FIGS. 5A and 58 are figures illustrating an example of the integration point Pn. FIG. 5A illustrates a mesh obtained by dividing a triangular patch by inserting a virtual point Ps (similar to FIG. 4B). FIG. 5B is a figure illustrating an integration point P1 calculated from a virtual point Ps and a point P6, i.e., points at both ends of the edge L′1.

The integration point Pn may be calculated as a point where a summation of distances from other triangular patches sharing the end opposite to the integration point Pn each edge is the smallest. In this explanation, “a distance from a triangular patch” is as follows. When a given triangular patch is an infinite plane, the distance from the triangular patch means a length of a perpendicular line drawn from the integration point Pn to the infinite plane. For example, the integration point P1 is calculated as a point having the smallest summation of distances from a triangular patch P1P2P6, a triangular patch P2P3P6, and a triangular patch P3P5P6, which share the vertex P6, i.e., an end of the edge L′1 opposite to the integration point P1 (in the present embodiment, this is defined as “transformation cost”). When an end of a given edge opposite to the integration point Pn is a vertex corresponding to an outermost pixel of the input image (such as the vertices P1 to P4 of FIGS. 5A, 5B), the integration point Pn may be set at a vertex corresponding to the outermost pixel.

The method for calculating the integration point Pn is not limited to the method as described above. For example, a middle point of an edge may be adopted as an integration point. On the other hand, the transformation cost may not be obtained by the method as described above. For example, an average value of the degrees of approximations S of triangular patches adjacent to both end points of an edge may be obtained. Without dividing a triangular patch to be evaluated, a vertex corresponding to an integration point Pn is moved, and thereafter, an average value of the degrees of approximations S of triangular patches adjacent to the vertex may be obtained, whereby an absolute value of a difference thereof may be adopted as a transformation cost. For example, it is possible to use a method described in M. Garland and P. S. Heckbert, “Surface simplification using quadric error metrics” In Computer Graphics (Proc SIGGRAPH 97), pages 209-216, ACM Press, New York, 1997.

The second determination unit 106 determines whether the smallest transformation cost among the transformation costs calculated for the respective edges is less than a predetermined threshold value defined in advance (S210).

When the determination made in step S210 is NO, the second determination unit 106 notifies the coordinate (xₛ, yₛ, Icₛ) of the virtual point Ps to the dividing unit 107.

The dividing unit 107 reads the mesh from the storage unit 31. Like FIG. 4, the dividing unit 107 inserts the notified virtual point Ps into the read mesh. The dividing unit 107 draws an edge between the virtual point Ps and each vertex of the triangular patch including the virtual point Ps, and divides the triangular patch (S211). At the same time, the dividing unit 107 removes the undivided triangular patch from the mesh.

When the determination made in step S210 is YES, the second determination unit 106 notifies, to the transformation unit 108, the vertex ID of the vertex, which is opposite to the virtual point Ps, of the edge having the smallest transformation cost among the three edges and the coordinate of the integration point Pn corresponding to the determined edge.

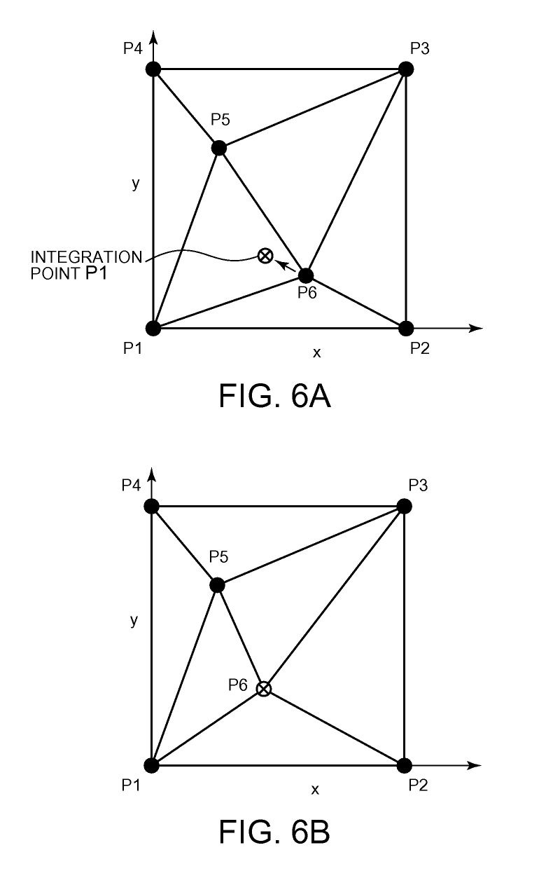

The transformation unit 108 reads the mesh from the storage unit 31. The transformation unit 108 moves the vertex having the vertex ID thus notified to the coordinate of the notified integration point, thereby transforming the triangular patch (S212). FIGS. 6A and 6B are figures illustrating an example of triangular patches transformed by the transformation unit 108. For example, when the transformation cost of the integration point P1 is less than the predetermined threshold value in FIGS. 5A and 5B, the transformation unit 108 moves the vertex P6 to the coordinate of the integration point P1, thereby transforming the triangular patch.

The correction unit 109 corrects the mesh by swapping the edges of the mesh so that the plurality of triangular patches included in the mesh divided by the dividing unit 107 or the mesh changed by the transformation unit 108 are in accordance with the rule of Delaunay triangulation (S213) The correction unit 109 updates the mesh by writing the corrected mesh to the storage unit 31. At this occasion, the correction unit 109 may reassign vertex IDs, edge IDs, and patch IDs in the updated mesh. Thereafter, step S203 is performed.

When the determination made in step S203 is YES, the drawing unit 13 reads the mesh from the storage unit 31, and draws the mesh (S214). The drawing unit 13 enlarge/reduces the mesh in x axis and y axis directions according to the size of the image to be displayed. The drawing unit 13 may draw the mesh using a well-known method in the field of computer graphics.

### Second Embodiment

An image processing apparatus according to a modification of the present embodiment is different in that, when an input image is a color image having RGB color components, the image processing apparatus does not use the luminance Ic of each color component but uses a luminance signal Y to generate a mesh.

When the input image is a color image having RGB color components, an input unit 11 converts the color components RGB of the input image into the luminance signal Y, and stores the luminance signal Y in a storage unit 31. The processings after that are carried in the same manner (steps S202 to S213).

A drawing unit 13 reads the input image from the storage unit 31, and draws the mesh based on the color components RGB of the input image and the luminance signal Y of the mesh.

Thus, it is possible to reduce the memory usage and the processing cost for generating the mesh for each color component.

In the above embodiment, the image processing apparatus can generate the mesh which hardly deteriorates the quality of the image as compared with the pixel image while the number of patches is prevented from increasing. Since the number of patches is prevented from increasing, the memory usage can be reduced.

Although several embodiments of the present invention have been hereinabove explained, the embodiments are shown as examples, and are not intended to limit the scope of the invention. These novel embodiments can be carried out in various other forms, and can be subjected to various kinds of omissions, replacements, and changes without deviating from the gist of the invention. These embodiments and the modifications thereof are included in the scope and the gist of the invention, and are included in the invention described in claims and a scope equivalent thereto.

What is claimed is:

1. An image processing apparatus processing an image in a virtual space defined by a position and a luminance comprising:
a generation unit for generating a mesh including a plurality of triangular patches, wherein the mesh has vertices at points corresponding to pixels at corners of an input pixel image;
a calculation unit for inserting a virtual point,
said calculation unit generating an edge connecting between the virtual point and the vertex of the triangular patch including the virtual point,
said calculation unit further calculating, for the edge, a coordinate of an integration point obtained by integrating the virtual point and the vertex,
said calculation unit further calculating, for the coordinates of the integration point, a transformation cost based on a distance from the triangular patch;
a determination unit for determining whether the transformation cost calculated for the coordinate of the integration point is less than a predetermined threshold value;
a dividing unit for inserting the virtual point to the mesh to divide the triangular patch including the virtual point, when the transformation cost calculated for the coordinate of the integration point is determined to be equal to or more than the predetermined threshold value; and
a transformation unit for transforming the triangular patch,
when the transformation cost calculated for the coordinate of the integration point is determined to be less than the predetermined threshold value,
said transformation unit for moving the vertex, which is opposite to the virtual point, of the edge having the integration point, to a position of the coordinate of the integration point having the transformation cost.

2. The image processing apparatus according to claim 1 further comprising,
a first calculation unit for calculating a degree of approximation of an image quality of the triangular patches with respect to the input image, on the basis of a difference between a luminance of each pixel of the pixel image and a luminance of the triangular patches corresponding to each pixel, said first calculation unit further calculating a maximum pixel at which the difference is the largest,
wherein said calculation unit inserts the virtual point at a coordinate of the maximum pixel

3. The image processing apparatus according to claim 2 further comprising,
a first determination unit for determining whether the degree of approximation is less than a predetermined threshold value,
wherein when the degree of approximation is determined to be less than the predetermined threshold value, said calculation unit inserts the virtual point at a coordinate of the maximum pixel

4. The image processing apparatus according to claim 3, wherein
said calculation unit further includes,
a second calculation unit for inserting a virtual point at a coordinate of the maximum pixel, when the degree of approximation is determined to be less than the predetermined threshold value, said second calculation unit further generating an edge connecting between the virtual point and each vertex of the triangular patch including the virtual point, said second calculation unit further calculating, for each edge, a coordinate of an integration point obtained by integrating the virtual point and the vertex, said second calculation unit further calculating, for each of the coordinates of the integration points, a transformation cost based on distances from the plurality of triangular patches;
said determination unit further includes,
a second determination unit for determining whether the smallest transformation cost among the transformation costs calculated for the respective coordinates of the integration points is less than a predetermined threshold value;
wherein said dividing unit inserts the virtual point to the mesh to divide the triangular patch including the virtual point, when the smallest transformation cost among the transformation costs calculated for the respective coordinates of the integration points is determined to be equal to or more than the predetermined threshold value.

5. The image processing apparatus according to claim 4, wherein the second calculation unit calculates, as the integration point, a point where a summation of distances with respect to the plurality of triangular patches sharing the vertex at the end of the edge in the virtual space is the smallest.

6. The image processing apparatus according to claim 4, wherein the second calculation unit calculates, as the integration point, a middle point between the vertex and the virtual point, which are both ends of the edge in the virtual space.

7. The image processing apparatus according to claim 4 further comprising,
a correction unit for correcting the mesh, so that no vertex of any other triangular patch is inside a circumcircle of the triangular patch included in the mesh including the triangular patch divided by the dividing unit or the mesh including the triangular patch transformed by the transformation unit; and
a drawing unit for drawing the mesh.

8. An image processing method comprising:
generating a mesh including a plurality of triangular patches in a virtual space defined by a position and a luminance, wherein the mesh has vertices at points corresponding to pixels at corners of an input pixel image by a generation unit;
calculating a degree of approximation of an image quality of the triangular patches with respect to the input image, on the basis of a difference between a luminance of each pixel of the pixel image and a luminance of the triangular patches corresponding to each pixel, and further calculating a maximum pixel at which the difference diff is the largest by a first calculation unit;
determining whether the degree of approximation is less than a predetermined threshold value, by a first determination unit;
inserting a virtual point at a coordinate of the maximum pixel, when the degree of approximation is determined to be less than the predetermined threshold value, generating an edge connecting between the virtual point and each vertex of the triangular patch including the virtual point, calculating, for each edge, a coordinate of an integration point obtained by integrating the virtual point and the vertex, and calculating, for each of the coordinates of the integration points, a transformation cost based on distances from the plurality of triangular patches, by a second calculation unit;
determining whether the smallest transformation cost among the transformation costs calculated for the respective coordinates of the integration points is less than a predetermined threshold value by a second determination unit;
inserting the virtual point to the mesh to divide the triangular patch including the virtual point, when the smallest transformation cost among the transformation costs calculated for the respective coordinates of the integration points is determined to be equal to or more than the predetermined threshold value, by a dividing unit.
moving the vertex, which is opposite to the virtual point, of the edge having the integration point, to a position of the coordinate of the integration point having the transformation cost, and transforming the triangular patch, when the smallest transformation cost among the transformation costs calculated for the respective coordinates of the integration points is determined to be less than the predetermined threshold value, by an transformation unit.

9. The image processing method according to claim 8, wherein said step of the second calculation unit further includes calculating, as the integration point, a point where a summation of distances with respect to the plurality of triangular patches sharing the vertex at the end of the edge in the virtual space is the smallest.

10. The image processing method according to claim 8, wherein said step of the second calculation unit further includes calculating, as the integration point, a middle point between the vertex and the virtual point, which are both ends of the edge in the virtual space.

11. The image processing method according to claim 8 further comprising,
correcting the mesh by a correction unit, so that no vertex of any other triangular patch is inside a circumcircle of the triangular patch included in the mesh including the triangular patch divided by the dividing unit or the mesh including the triangular patch transformed by the transformation unit; and
drawing the mesh by a drawing unit.

12. An image processing program for causing a computer editing an image, stored in a recordable medium:
a unit which generates a mesh including a plurality of triangular patches in a virtual space defined by a position and a luminance, wherein the mesh has vertices at points corresponding to pixels at corners of an input pixel image;
a unit which calculates a degree of approximation of an image quality of the triangular patches with respect to the input image, on the basis of a difference between a luminance of each pixel of the pixel image and a luminance of the triangular patches corresponding to each pixel, and further calculates a maximum pixel at which the difference is the largest;
a unit which determines whether the degree of approximation is less than a predetermined threshold value;
a unit which inserts a virtual point at a coordinate of the maximum pixel, when the degree of approximation is determined to be less than the predetermined threshold value, said unit which generates an edge connecting between the virtual point and each vertex of the triangular patch including the virtual point, said unit which calculates, for each edge, a coordinate of an integration point obtained by uniting the virtual point and the vertex, and said unit which calculates, for each of the coordinates of the integration points, a transformation cost based on distances from the plurality of triangular patches;
a unit which determines whether the smallest transformation cost among the transformation costs calculated for the respective coordinates of the integration points is less than a predetermined threshold value;
a unit which inserts the virtual point to the mesh to divide the triangular patch including the virtual point, when the smallest transformation cost among the transformation costs calculated for the respective coordinates of the integration points is determined to be equal to or more than the predetermined threshold value; and
a unit which moves the vertex, which is opposite to the virtual point, of the edge having the integration point to a position of the coordinate of the integration point having the transformation cost, and transforming the triangular patch, when the smallest transformation cost among the transformation costs calculated for the respective coordinates of the integration points is determined to be less than the predetermined threshold value.

13. The image processing program according to claim 12,
wherein said unit of the second calculation calculates, as the integration point, a point where a summation of distances with respect to the plurality of triangular patches sharing the vertex at the end of the edge in the virtual space is the smallest.

14. The image processing program according to claim 12,
wherein said unit of the second calculation calculates, as the integration point, a middle point between the vertex and the virtual point, which are both ends of the edge in the virtual space.

15. The image processing program according to claim 12 further comprising,
a unit for correcting the mesh, so that no vertex of any other triangular patch is inside a circumcircle of the triangular patch included in the mesh including the triangular patch divided by the unit of the dividing or the mesh including the triangular patch transformed by the unit of the transformation; and
a unit for drawing the mesh.
